(19) United States
(12) Patent Application Publication
(10) Pub. No.: US 2007/0129953 A1
(43) Pub. Date: Jun. 7, 2007

(54) Methods and systems for information strategy management

(75) Inventors: John Cunningham, Danville, CA (US); Gilles Vergnory-Mion, Meudon (FR); Ranvir Wadera, San Mateo, CA (US)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: Business Objects Americas, San Jose, CA (US)

(21) Appl. No.: 10/683,170

(22) Filed: Oct. 8, 2003

Related U.S. Application Data
(60) Provisional application No. 60/417,811, filed on Oct. 9, 2002.

(51) Int. Cl. G06Q 99/00

(52) U.S. Cl. 705/1

(57) ABSTRACT

Systems and methods for information strategy management enable users to define and automate the flow and use of business intelligence within an organization. Users who to receive specific business intelligence content are identified by reference to their roles within the organization. The content, and conditions under which it is sent, are definable with reference to variables associated with specific users or roles. Next steps suggesting specific tasks to be performed in response to the content may also be sent to users in association with the content. User activity in response to received content or next steps may be recorded, enabling an organization to monitor how information is being used.

### CROSS-REFERENCES TO RELATED APPLICATIONS

This application claims the benefit of U.S. Provisional Application No. 60/417,811, filed Oct. 9, 2002, entitled “Method and System for Information Practice Management,” which disclosure is incorporated herein by reference for all purposes.

### BACKGROUND OF THE INVENTION

The present invention relates generally to business information systems and in particular to systems and methods for managing information strategies (also referred to as “information practices”) of an organization.

Organizations use various business intelligence tools to help monitor the performance of their operations. In general, a business intelligence tool works with items of data housed in a database or other data repository to generate various metrics (typically a quantity computed from database objects, e.g., “total expenses for the month”), reports (a presentation of data and/or metrics in an easily digestible form), and the like. Various tools exist for defining metrics, generating reports, and distributing information to users or groups of users.

Ideally, any particular item of business intelligence is distributed to all of the members of the organization (and only to those members) who need the information in order to make decisions, and the recipients of an item act on it in an efficient and reproducible manner. The flow and use of business intelligence can be referred to as “information strategy.” Most successful organizations develop a set of “best practices” for routing and handling particular items of information that help them manage information effectively. These best practices, however, are not easily captured and hence not easily reusable. Often, these practices are developed by individuals and not documented or shared with others. When such an individual leaves, the associated information strategies are lost as well, resulting in inconsistent or inefficient organizational responses to information.

Existing business intelligence systems generally provide capabilities for accessing and analyzing business intelligence information (e.g., automatically generating certain reports), but they provide only limited capability for managing information strategy. For example, users can set up filters and/or distribution lists to select the information they want or to send information to others who are likely to be interested. But filtering by individual users tends to be idiosyncratic so that others in the organization cannot be certain whether a user has received particular information or what the user has done in response. Distribution lists provide senders with some assurance that information is reaching an intended recipient, but as individuals' responsibilities within the organization change, distribution lists can easily become out-of-date, and individuals who take on new roles may continue to receive information they no longer need or fail to receive information they need in their new roles. Relying on distribution lists generally does not ensure that the right information reaches the right people.

Therefore, improved tools for directing business intelligence to the attention of individuals who need to know it and for helping those individuals decide how to respond to received business intelligence would be desirable.

### BRIEF SUMMARY OF THE INVENTION

Embodiments of the present invention provide systems and methods for managing information strategies (i.e., the flow and use of business intelligence) of an organization. Some embodiments provide users the ability to specify what business intelligence content should be sent, to whom, under what conditions, and what the recipients should do with the content. Some embodiments also enable users who receive content (and in some instances other users as well) to record and view information reflecting actions that were taken in response to the content.

According to one aspect of the present invention, a method for managing business intelligence is provided. Business intelligence content to be sent is identified. A target role to which the business intelligence content should be sent is identified, with the target role having a role definition. The role definition is applied to a user data store, thereby identifying a recipient user. The business intelligence content is sent to the recipient user. In some instances, the business intelligence content may be sent in response to detecting an occurrence of a condition. The condition may be defined with a parameter, and detecting the occurrence of the condition may include resolving the parameter, e.g., by reference to the role definition of the target role and/or a user variable of the recipient user. In some embodiments, a next step associated with the business intelligence content may be identified, with the next step indicating a task to be performed by the recipient user in response to the business intelligence content; the next step nay be sent to the recipient user in association with the business intelligence content. In other embodiments, a target state of the business intelligence content and a deadline for reaching the target state may be identified; the target state and the deadline may be sent to the recipient user in association with the business intelligence content.

According to another aspect of the invention, a method for managing business intelligence is provided. Business intelligence content to be sent is identified. A recipient user for the business intelligence content is identified. A next step associated with the business intelligence content is identified; the next step indicates a task to be performed by the recipient user in response to the business intelligence content. The business intelligence content is sent to the recipient user in association with the next step. In some embodiments, response data may be received from the recipient user, with the response data indicating that the recipient user has performed the indicated task. The next step may be sent to multiple users, including the recipient user, in a shared form such that the response data received from the recipient user is visible to another one of the users. In some instances, identifying the next step may include resolving a next step parameter, e.g., by reference to a user variable of the recipient user and/or a role association of the recipient user.

According to yet another aspect of the invention, a system for managing business intelligence includes an information strategy repository, a role resolution engine, and an interpretation engine. The information strategy repository is configured to store a role definition and a flow. The flow references the role definition and also includes a definition of business intelligence content to be sent and a condition under which the business intelligence content is to be sent. The role resolution engine is configured to dynamically resolve the role definition, thereby identifying a recipient user who has a target role defined by the role definition. The interpretation engine is configured to execute the flow object, thereby sending the business intelligence content to the recipient user in the event that the condition is satisfied. The interpretation engine is further configured to identify the recipient user by providing the role definition to the role resolution engine. In some embodiments, the system may incorporate a business intelligence subsystem that includes a content server configured to receive and store business intelligence data and to generate a report from the business intelligence data, and a rules engine configured to process business rules to determine when the content server should generate the report.

The following detailed description together with the accompanying drawings will provide a better understanding of the nature and advantages of the present invention.

### BRIEF DESCRIPTION OF THE DRAWINGS

FIG. 1 is a simplified high-level block diagram of a system according to an embodiment of the present invention;

FIG. 2 is a block diagram of an information strategy management server according to an embodiment of the present invention;

FIG. 3 is a simplified data model diagram according to an embodiment of the present invention;

FIG. 4 is a flow diagram of a process for creating a role object according to an embodiment of the present invention;

FIG. 5A is a flow diagram of a process for creating a flow object according to an embodiment of the present invention;

FIGS. 5B-K are screen shots illustrating a user interface for creating a flow object according to an embodiment of the present invention;

FIG. 5L is a control flow diagram of a process for creating a flow according to an embodiment of the present invention;

FIG. 6 is a flow diagram of a process for creating a goal object according to an embodiment of the present invention;

FIG. 7A is a flow diagram of a process for executing a flow object according to an embodiment of the present invention;

FIG. 7B is a control flow diagram of a process for executing a flow according to an embodiment of the present invention.

FIG. 8 is an illustration of elements of a live content display for an information consumer according to an embodiment of the present invention; and

FIG. 9 is an illustration of an information insight element of a live content display according to an embodiment of the present invention.

### DETAILED DESCRIPTION OF THE INVENTION

Embodiments of the present invention provide systems and methods for managing information strategies (i.e., the flow and use of business intelligence) of an organization. In some embodiments, information strategy is modeled using one or more information-flow objects, referred to herein as “flows” or “flow objects.” Each flow object specifies a procedure for handling a specific item of business intelligence. For example, a flow object can specify that a report containing certain data (e.g., an inventory report) is to be sent to one or more users in a certain role (e.g., an inventory manager), under a specified condition (e.g., the quantity of a stock item drops below a threshold). Flows are executed to detect occurrence of the condition and send appropriate data to the selected users. (The data sent is referred to herein as an “instance” of the flow.)

A flow object can also identify one or more “next steps,” i.e., suggested actions to be taken by the recipient(s) of the flow (e.g., order more of the stock item). These actions can be selected so as to reflect the preferred practices of the organization. Next steps can be customized to a particular user, based on considerations such as the user's role within the organization, the department in which the user works, the criticality of the condition that caused the next steps to be generated, historical information, and so on. The next steps can be presented to a user in various forms, such as a task list entry, a link to a pre-filled electronic form, a new flow to be initiated, etc. In some embodiments, next steps can be shared among multiple users so that each user knows whether another user has taken any of the recommended actions. Next steps can also be monitored (e.g., by supervisors of the users who receive them).

In another embodiment, other aspects of information strategy are modeled by defining “goal” objects that enable managers and subordinates to set specific, quantitative objectives and to measure their progress. For example, a production manager might have a goal of reducing the number of defective products made by 50% over the next six months. A goal object may specify the users in a certain role who are responsible for accomplishing the goal (e.g., the production team), a quantitative or qualitative target to be met, and a deadline for meeting the target. Some goal objects may also include checkpoints (intermediate milestones to be achieved at certain dates between the starting and ending dates). Once defined, goal object data is sent to the users responsible for achieving the goal, and an interface is provided for these users (and their supervisors) to monitor their progress toward the goal. In some embodiments, the goals assigned to a user in a particular role may be used in determining which content to send to that user. For example, if a production manager has a goal of reducing the number of defective products, information regarding defective products (e.g., number of defective units, type of defect, etc.) can be periodically sent to the production manager.

Users who receive information flows or are responsible for achieving goals are advantageously identified in terms of a “role” within the organization. In general terms, a role corresponds to a job responsibility (e.g., ordering new stock), and one or more users may be associated with a particular role. Role identifications may, but are not required to, correspond to job titles (e.g., inventory manager) used by the organization, and a user with only one job title may be associated with multiple roles. A database can be used to associate one or more users with a particular role; as the database is updated to reflect changing responsibilities, the same role identification will cause information to be sent to a different user. This dynamic role-based identification supports continuity of information strategies in the face of changing individual responsibilities. In one implementation, roles are defined using role objects, and relationships can be defined between roles (e.g., the “developer” role reports to the “development manager” role). In the context of an information strategy that includes a number of related flows and/or goals, roles and their relationships can be used to manage access control for particular flows and/or goals.

An organization's information strategies can be described by defining a “practice” object that incorporates a group of role definitions, flows, and/or goals. The flows and goals of a practice may be related or interconnected in various ways. For example, a next step associated with one flow may trigger another flow or creation of a goal. Or, the same event may trigger multiple flows, with the same or different information being directed to different users. In some embodiments, the roles, flows, and goals making up an information strategy can be packaged for reuse in another organization or another information strategy management system.

Examples of systems and methods for defining and managing information flows and goals in accordance with the present invention will now be described.

I. System Overview

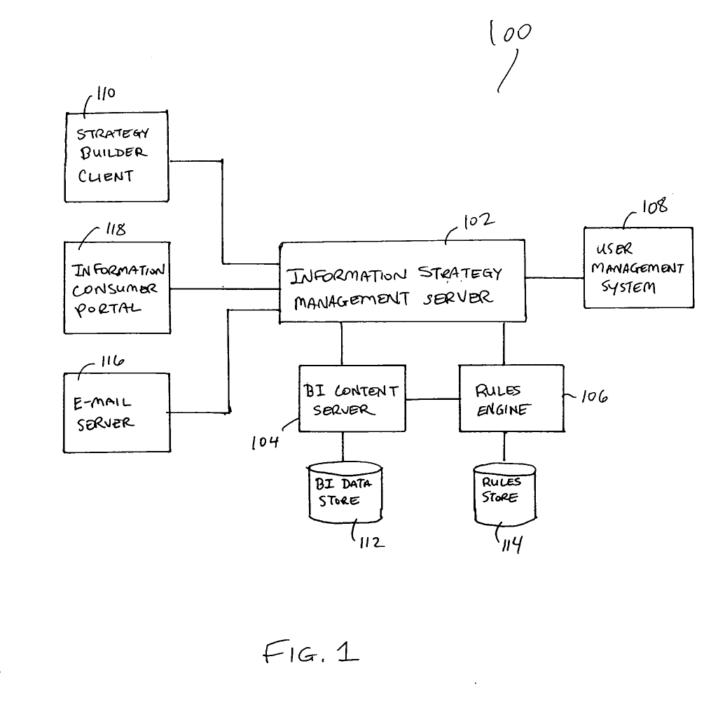

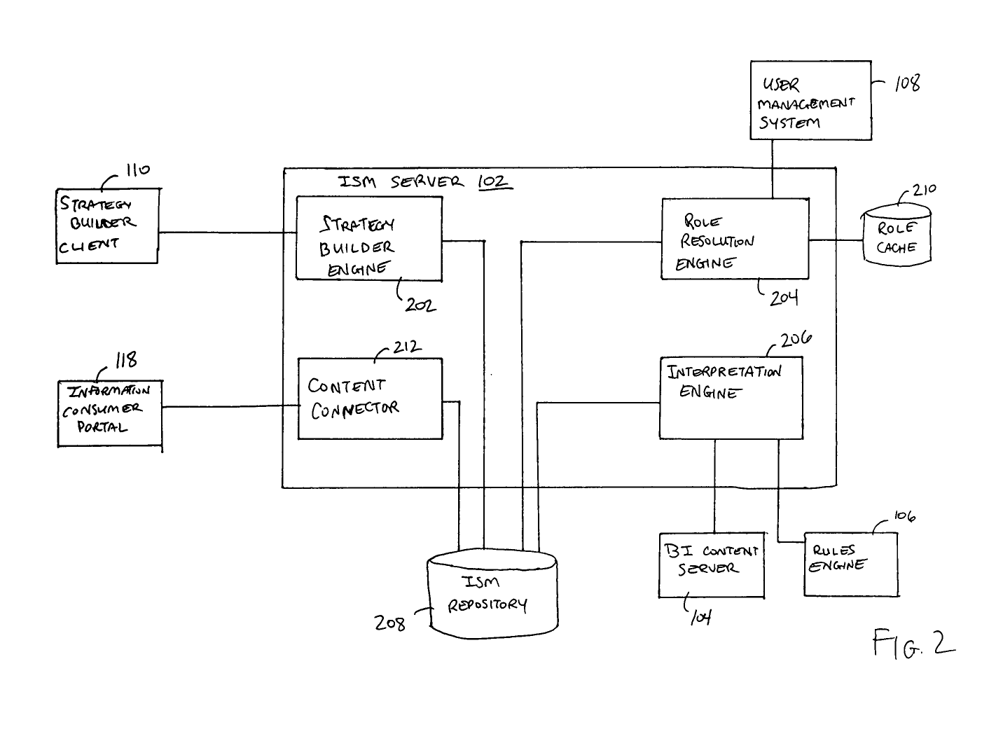

FIG. 1 is a simplified high level block diagram of a system 100 for managing business intelligence according to an embodiment of the present invention. The system 100 includes an information strategy management (ISM) server 102 interacting with a business intelligence (BI) content server 104, a rules engine 106, a user management system 108, and a strategy builder client 110.

In one embodiment, BI content server 104 supports conventional BI functionality such as storing data related to the organization's operations (e.g., production, sales, purchasing, expenses, etc.) in a BI data store 112 and generating reports from the stored data. Any type of data may be stored in BI data store 112, which may be implemented using conventional database technologies. A report generated by BI content server 104 presents one or more items of business intelligence to a user. Reports may be generated in a variety of formats, including simple notifications (e.g., on-screen alert messages), documents that present data (such documents may also include other metrics or analytics such as aggregations and averages, and data may be presented in various forms including tables, charts, etc.), and other formats well known in the art. Thus the term “report” as used herein is to be understood as including any presentation of business intelligence to a user and is not limited to particular formats or content.

Rules engine 106, which may also be of generally conventional design, supports automatic report creation in accordance with a set of business rules that may be stored in a rules data store 114. Rules engine 106 processes rules contained in rules data store 114 from time to time to determine which reports should be generated and transmitted to various users. In some embodiments, a rule for generating a report includes a trigger, an exception, and a specification of the report to be generated. The trigger identifies an event whose occurrence signals that rules engine 106 should test the exception, and occurrence or non-occurrence of the exception determines whether the specified report is generated. For example, the trigger might be a particular time of day (e.g., 2:00 a.m.), an update of BI data store 112, a predefined polling interval, or the like. The exception may be defined in terms of data stored in BI data store 112 and available to rules engine 106 via BI content server 104. For example, an exception may be defined as a particular metric exceeding or falling below a threshold (e.g., quantity of an item in stock falling below a minimum acceptable level). It is also possible to define a rule such that the triggering event also acts as the exception, e.g., to send a weekly report on inventory to a particular person.

When the exception occurs, a report is generated and transmitted to the user. Transmission to the user may take various forms, including e-mail (via an e-mail server 116), pop-up alert messages on a user's screen (e.g., via an information consumer portal 118 described below), messages delivered via various interfaces (not shown) to a voice mail system, mobile phone, personal digital assistant (PDA), and so on. In some instances, the user may be sent a link (e.g., using hyperlinks implemented in HTTP) that the user can activate to view the actual report.

It will be appreciated that the functionality described herein for BI content server 104 and rules engine 106 may be provided using conventional products, such as BusinessObjects WebIntelligence, BusinessObjects Broadcast Agent, and BusinessObjects Application Foundation. In these products, rules engine 106 is integrated into BI content server 104. A further description of these system components is omitted as not being crucial to understanding the present invention.

User management system 108 may also be of generally conventional design and may include a personnel database product or system that keeps track of information about members of the organization, e.g., using an LDAP (Lightweight Directory Access Protocol) database. The personnel database advantageously stores information for each member of the organization such as name, e-mail address, job title, department, supervisor (name and/or position), location, etc. Each member who will receive information via system 100 is advantageously assigned a unique identifier (such as a login name for the ISM system 100), and that identifier is advantageously stored in the personnel database. A detailed description of user management system 108 is omitted as not being critical to understanding the present invention.

Strategy builder client 110 enables authorized users to manage a set of information strategy objects, which generally include various role, flow, and goal objects. Via strategy builder client 110, a user can create, modify, activate, deactivate, or remove any of these objects, as described below.

In accordance with the present invention, ISM server 102 leverages and enhances the functionality of BI content server 104, rules engine 106, and user management system 108 to create, define and execute information strategies for an organization. For example, ISM server 102 may be provided (via strategy builder client 110) with a flow object that is to be instantiated and sent to users in a particular role according to a certain rule. ISM server 102 can access user management system 108 to identify users having that role, access rules engine 106 to evaluate the rule, and access BI content server 104 to generate a report for the user. ISM server 102 may also customize information that is sent to a particular user using role-specific or user-specific variables as described below, generate recommended actions (next steps) to be sent to the user as part of the flow, and so on.

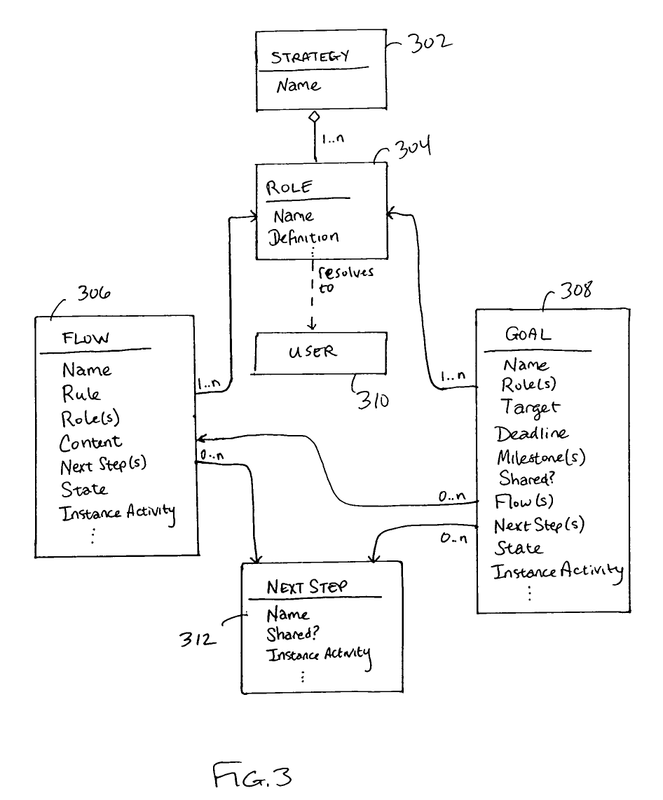

FIG. 2 is a functional block diagram of an ISM server 102 according to an embodiment of the present invention. In this embodiment, ISM server 102 includes a strategy builder engine 202, a role resolution engine 204, an interpretation engine 206, and a content connector 212. These components communicate with each other as described below (lines are not shown) and with an ISM repository 208 that stores data defining information strategies and data related to active information flows within the organization.

Strategy builder engine 202 interacts with strategy builder client 110 to enable a strategy builder to define and update information strategies, including roles, flows, next steps, and goals. The term “strategy builder” refers to a user who has the authority to define and/or modify an organization's information strategies; such a user may be, e.g., a system administrator or a manager within the organization. Strategy builder interface 202 may include appropriate security features (e.g., user identification, password protection and/or other user authentication measures) to prevent unauthorized users from modifying information strategy data. In addition, the ability to modify information strategy data may be assigned in different degrees to different users. For example, all users may be authorized to create, edit, and/or delete a goal object or flow object directed to their own roles or themselves, while only certain users are allowed to create, edit, and/or delete goal objects or flow objects directed to someone else.

In one embodiment, strategy builder engine 202 receives input and generates or updates appropriate objects (e.g., goals, flows, roles, practices) using a scripting language such as XML, Java (e.g., in the Java 2 Enterprise Edition (J2EE) platform from Sun Microsystems), etc. These objects are stored in ISM repository 208. Examples of specific processes for defining roles, flows, and goals that may be supported by strategy builder engine 202 are described below. Strategy builder 202 may interact with role resolution engine 204 and/or interpretation engine 206 in order to validate object definitions.

Role resolution engine 204 resolves role objects to specific users within the organization by interacting with user management system 108. In some embodiments, role resolution engine 204 is configured to dynamically associate users (i.e., individuals in the organization) with roles (i.e., specific areas of responsibility), as described below. During role definition, role resolution engine 204 may be used by strategy builder engine 202 to validate new definitions. During processing of flows, role resolution engine 204 may be used by interpretation engine 206 to obtain lists of users to receive a flow.

Role resolution engine 204 is advantageously configured to read but not write to a personnel database maintained by user management system 108. Role resolution information, such as lists of users to whom a particular role resolves, may be maintained in a role cache 210 accessible to role resolution engine 204. Role cache 210 advantageously stores unique identifiers that can be used to direct content to the users associated with each defined role. Role resolution engine 204 updates role cache 210 periodically by referencing the role definitions stored in ISM repository 208 and performing appropriate queries to user management system 108.

Roles may be defined statically or dynamically. In some embodiments, some roles are defined statically while other roles are defined dynamically. Static role definitions may be provided, e.g., by defining a distribution list that contains unique identifiers (e.g., login names) of users who have a particular role. The distribution list may be stored in role cache 210 and/or in ISM repository 208, and may be manually updated via strategy builder engine 202.

A dynamic role may be defined by a query (e.g., an LDAP query) that is processed by user management system 108, which returns a list of users satisfying the query. For example, the query may be based on one or more fields in the organization's personnel database, such as department, job title, location, and/or supervisor. The list of users returned by user management system 108 is stored in role cache 210. Role resolution engine 204 may be configured to execute the role-defining query periodically, e.g., nightly, so that the list of users associated with the role in role cache 210 remains current (provided, of course, that the personnel database of user management system 108 is kept up to date).

It will be appreciated that updating of role cache 210 by periodic execution of queries may result in time periods when role cache 210 is not current. (For example, a user may be promoted to a new position in the morning, but this would not be reflected until the next day if role resolution engine 204 updates role cache 210 nightly.) To minimize out-of-date information, user management system 108 may be configured to notify role resolution engine 204 when the personnel database is updated so that role resolution engine 204 may re-execute queries for some or all dynamic roles, rather than waiting for a regularly scheduled update. A user interface to user management system 108 may be modified to enable a personnel manager to initiate the notification, or notification may occur automatically with each update or batch of updates.

In some embodiments, a role may be defined to contain one or more other roles. For example, a role definition may include both a distribution list and a reference to a dynamic role definition. Multiple levels of containment can be supported in this manner, as long as each role ultimately resolves to at least one user. In some embodiments, roles that resolve to no users may be allowed; in other embodiments, role resolution engine 204 is programmed to send an alert message (e.g., to strategy builders) when a role fails to resolve.

As described below, information about a specific user in a role may be used during execution of a flow to personalize the delivery of information to each user who shares a role. User-specific information may be stored in role cache 210 in connection with the list of users in a particular role, or obtained as needed by querying user management system 108. The information stored in role cache 210 may be optimized based on considerations such as the storage space available in role cache 210, the likelihood that information in role cache 210 might become out of date, and the time required to access user management system 108 as flows are being processed. For example, in implementations where keeping role cache 210 up to date is a significant concern, minimizing the amount of information contained therein may be desirable. Where access to user management system 108 creates a substantial bottleneck, more information may be stored in role cache 210.

It is to be understood that the implementation of roles may vary, and that in some embodiments, role information may be stored by the user management system rather than in a separate role cache. In some embodiments, role resolution engine 204 generates an error message or warning during an update in the event that a role fails to resolve to any users. While not required, such a warning can help prevent missed deliveries of information.

Interpretation engine 206 interacts with rules engine 106, BI content server 104, and role resolution engine 204 to execute flows that are stored in ISM repository 208, as described below. Interpretation engine 206 may also receive a newly defined flow in a test mode from strategy builder 202 and execute the flow for validation purposes. In some embodiments, interpretation engine 206 also processes goals for distribution to selected users.

Content connector 212 provides an interface between ISM repository 208 and an information consumer portal 118, via which an information consumer (e.g., a recipient of a flow) may view and update information strategy data, such as instances of flows or goals that have been sent to that consumer through operations of ISM server 102. Operations of portal 118 that are supported by content connector 212 are described below.

It will be appreciated that the system described herein is illustrative and that variations and modifications are possible. The various servers and systems described herein can be implemented on one or more computer systems of generally conventional design, with the various functional blocks implemented as one or more computer programs that can be distributed among the computer systems in any manner desired. Computer systems may communicate via various networks, including LANs, WANs, Internet, and so on. In one embodiment, the functionality described herein is implemented in software using J2EE, XML, and the like, and exchanged via protocols such as HTTP and TCP/IP. Those of ordinary skill in the art will recognize that software implementations using other platforms and/or programming or scripting languages are also possible, and the invention is not limited to any particular language. An ISM server may provide its own integrated rules engine and/or content servers rather than leveraging existing products. Alternatively, an ISM server may be configured to interact with multiple rules engines and/or BI content servers and/or user management systems. Special-purpose computer systems may also be constructed to carry out some or all of the functionality described herein.

II. Data Model

As described above, system 100 can be configured by a strategy builder to deliver particular information to the people who need it when they need it, accompanied by suggested actions to take in response. In some embodiments of the present invention, the strategy builder configures system 100 by defining information strategies, including role objects, flow objects, and/or goal objects, which are stored in ISM repository 208. ISM server 102 operates to create instances of these objects, which may be transmitted to selected recipients for notification purposes and/or for follow-up.

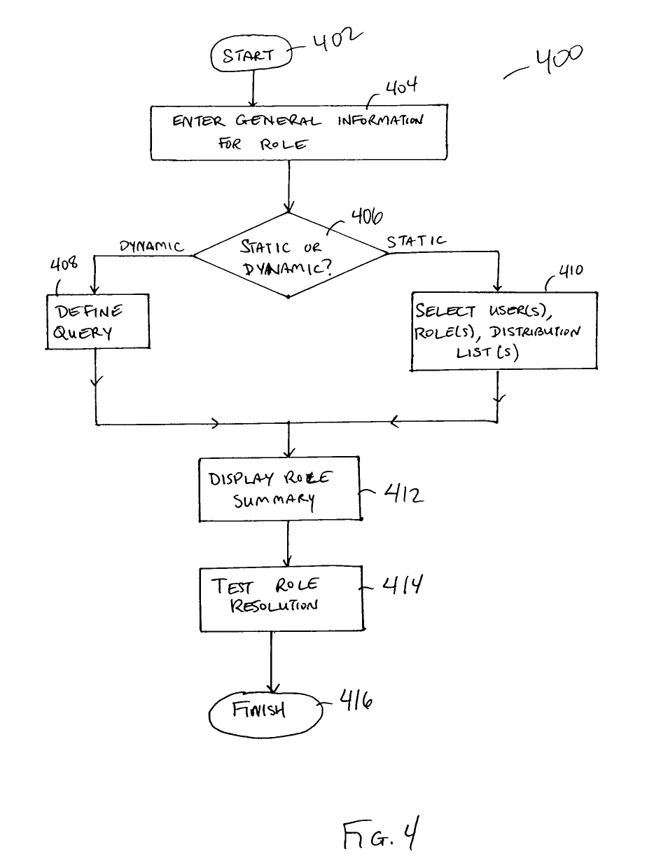

FIG. 3 is a diagram of a simplified data model according to an embodiment of the present invention. In this embodiment, a practice object 302 includes one or more role objects 304, one or more flow objects 306, and one or more goal objects 308. These objects may be stored, e.g., in ISM repository 208 of FIG. 2, so that they are accessible to ISM server 102. It is to be understood that this data model is illustrative, and that variations and modifications are possible.

A role object 304 has a name provides a role definition that resolves to one or more user objects 310. User objects 310 may be objects implemented in ISM server 102 of FIG. 1 or references to a data store accessible through user management system 108. Role definitions and resolution are described below.

A flow object 306 describes a discrete information flow that delivers content (an item of information) to specified users when appropriate. Flow object 306 includes a unique name (within the scope of practice object 302); a rule for determining when the content should be sent; references (indicated by the connecting arrow) to one or more role objects 304 for selecting the recipients to whom the content should be sent; a content definition, references to zero or more next step objects 312 to be included with the content; and a state indicator that may be set to an active or inactive state.

A goal object 308 describes a goal that may be assigned to one or more recipient users. Goal object 308 includes a unique name; references to one or more role objects 304 for selecting recipients of the goal; a target describing a desired condition; a deadline for reaching the target; zero or more intermediate milestones; references to zero or more flow objects 306 to be activated in connection with the goal; references to zero or more next step objects 312 to be included with the goal; and a state indicator that may be set to an active or inactive state.

A next step object 312 describes an action to be taken by a recipient, who receives the next step in connection with a flow or goal. Next step object 312 includes a unique name and a shared or unshared indicator, the use of which is described below.

In accordance with an embodiment the present invention, ISM server 102 processes the active goal and flow objects by creating instances of these objects (as well as any associated next steps) and delivering them to the recipients, who are designated by role. In order to track the response of recipients of these instances, goal objects, flow objects, and next step objects advantageously include additional data fields (labeled as “Instance Activity” in FIG. 3) for recording actions taken by recipients in response to the instance. These fields may be updated by a recipient, e.g., via information consumer portal 118 of FIG. 1.

Examples of processes for defining the various content fields shown in FIG. 3 will now be described. Execution of goals and flows, and actions that may be taken by recipients thereof will be described subsequently.

In this description, it is to be understood that a “strategy builder” is a user who has been given responsibility for defining an organization's information strategies. Any number of users may be strategy builders, depending on the organization's preferences. The strategy builder accesses ISM server 102 via strategy builder client 110, which communicates with strategy builder engine 202. As mentioned above, strategy builder client 110 and/or strategy builder 202 may include security features such as passwords or other user authentication protocols to exclude unauthorized users.

A. Information Strategy Object

Practice object 302 supports the binding together of various roles, flows, and goals that may be defined by an organization into a coherent whole by providing an object that associates role objects 304, flow objects 306, and goal objects 308 as subsidiaries. An organization may define one or more practice objects 302, and an organization with multiple strategy builders may establish system security such that different strategy builders access different practice objects.

The practice object advantageously provides scope for resolving roles, flows, goals, and the like. Since multiple practice objects are allowed, two roles in different practice objects could have the same name but be defined differently (e.g., resolve to a different set of users). For any given flow, the role will be resolved according to the definition associated with the practice object to which the flow belongs. Thus, practice object 302 facilitates management of a potentially large collection of flows, goals, roles, and the like. An organization with multiple strategy builders who are responsible for different areas of activity can provide that each strategy builder operates on a different practice object 302. For example, there might be a “production” practice object and a “sales” practice object.

Definition of information strategy objects 302 may be done through strategy builder interface 202. Initial creation of a practice object 302 may be as simple as giving it a name, with flow, role, and/or goal object associations being added as the various constituent objects are created. For instance, during the various object creation processes described below, the strategy builder may be prompted to select a practice object to which the new object is to be associated. Alternatively, the strategy builder may be prompted to select a practice object before creating any new constituent objects. In some embodiments, existing role, flow, or goal objects that are associated with one practice object can also be copied or moved to a different practice object.

B. Role Object

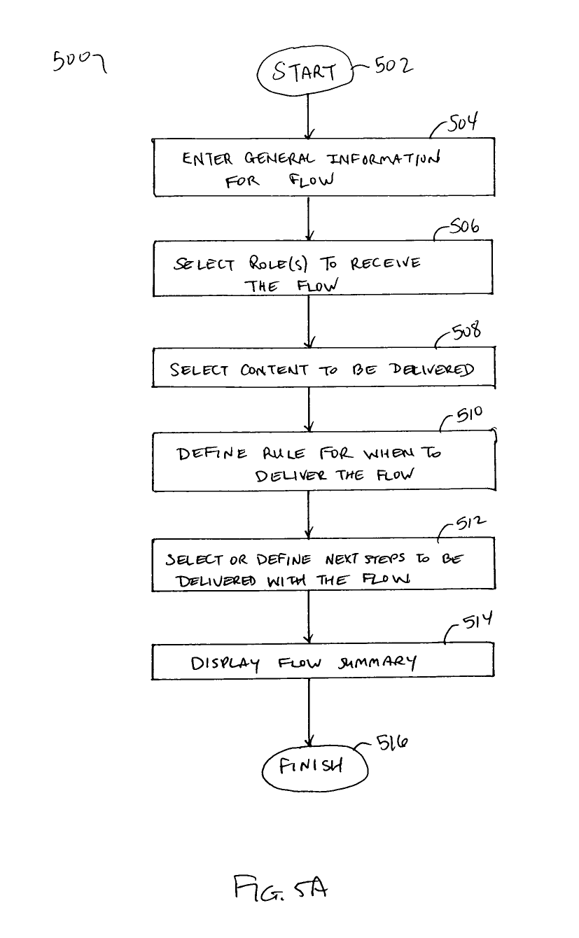

FIG. 4 is a flow diagram of a process 400 for defining a role object 304 according to an embodiment of the present invention. As described above, roles may be defined either statically or dynamically. The process of role creation generally includes assigning a name to the role and providing a definition that determines which users are to be associated with the role. Process 400 may be implemented via a “wizard” interface, i.e., a graphical user interface that enables the strategy builder to move backward and forward among the various steps until the strategy builder is satisfied with the definition, or other types of interfaces known in the art.

At step 402, the strategy builder initiates the role definition process, e.g., by selecting a “create role” command in a graphical user interface of strategy builder client 110 (FIG. 1). At step 404, the strategy builder enters general information for the new role objects. The general information typically includes a role name and may include additional information such as explanatory notes and values for zero or more role variables. Role variables may be defined by the strategy builder and used to contain any information about the role that the strategy builder wants to have available for customizing content delivery. For example, if a role object is created for a “Product X” development team and John Doe is the head of the team, a role variable of “leader” can be defined and assigned the value “John Doe.” The value in this example may also be defined by a query to user management system 108 (e.g., querying for supervisor of the users in this role) that can be executed when the role is resolved. Use of role variables in connection with information delivery is described below.

At step 406, the policy manager selects between a static or dynamic role definition. If a dynamic role definition is selected, then at step 408, the strategy builder enters a role-defining query to be executed. In some embodiments, step 408 includes checking the query for correct syntax and/or execution and notifying the strategy builder if any errors are detected.

If, at step 406, a static role definition is selected, then at step 410, the strategy builder selects one or more users and/or previously defined roles to be added to a distribution list for the new role. In some embodiments, step 410 includes displaying lists of user names (which may be obtained, e.g., by querying user management system 108) and previously defined role names (which may be obtained, e.g., from ISM repository 208). These displays may allow the strategy builder to view additional information about the users (e.g., job titles, locations, etc.) and/or roles (e.g., which users a role in the list resolves to). At step 410, the strategy builder may also have the option of querying user management system 108 to find users who have a particular characteristic. In other embodiments, the strategy builder can also define a distribution list for a role by reference to one or more e-mail distribution lists (e.g., on e-mail server 116), content server groups and/or user account profiles maintained by BI content server 104, or any other user grouping system supported by the organization.

At step 412, a role summary is displayed. The role summary typically includes the name, any variables that were defined, and the role definition (either the query or the list of users and/or roles). At step 414, the strategy builder is given the option to test the role resolution. When this test is invoked, strategy builder engine 202 provides the role definition to role resolution engine 204, which attempts to resolve the role, i.e., to identify one or more users associated with the role by interpreting the definition. The result of the test may be displayed, e.g., as a list of identified users, a confirmation that the role resolves to at least one user, or an error message indicating that the role does not resolve to any user.

At step 416, the strategy builder exits the role definition process, and the new role is stored in ISM repository 208. The new role may also be provided to role resolution engine 204, which resolves the role and stores the list of users in role cache 210. In some embodiments, the strategy builder may also elect to quit without saving the new role.

C. Flow Object

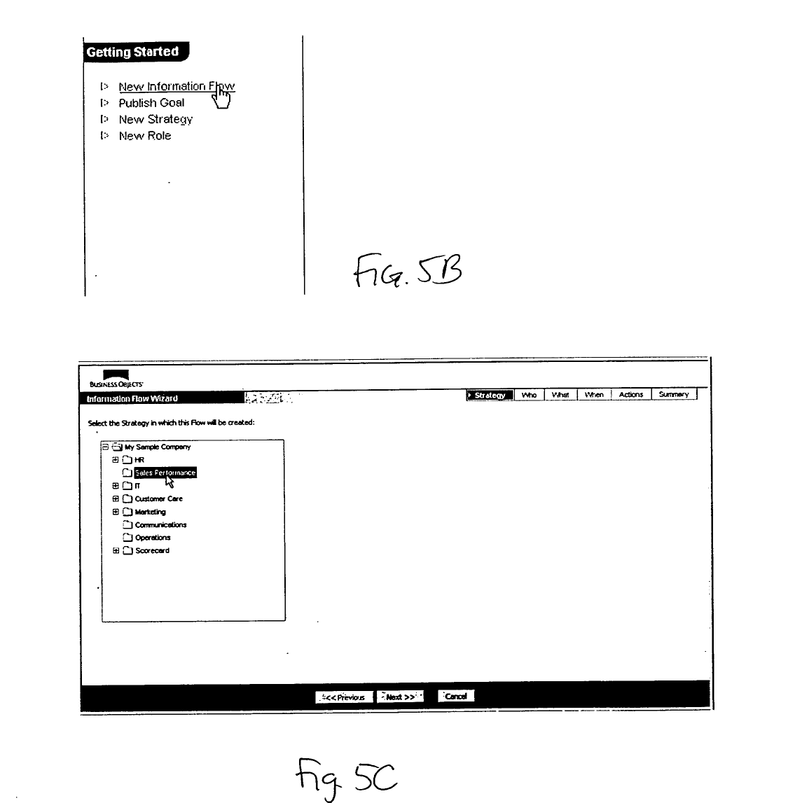

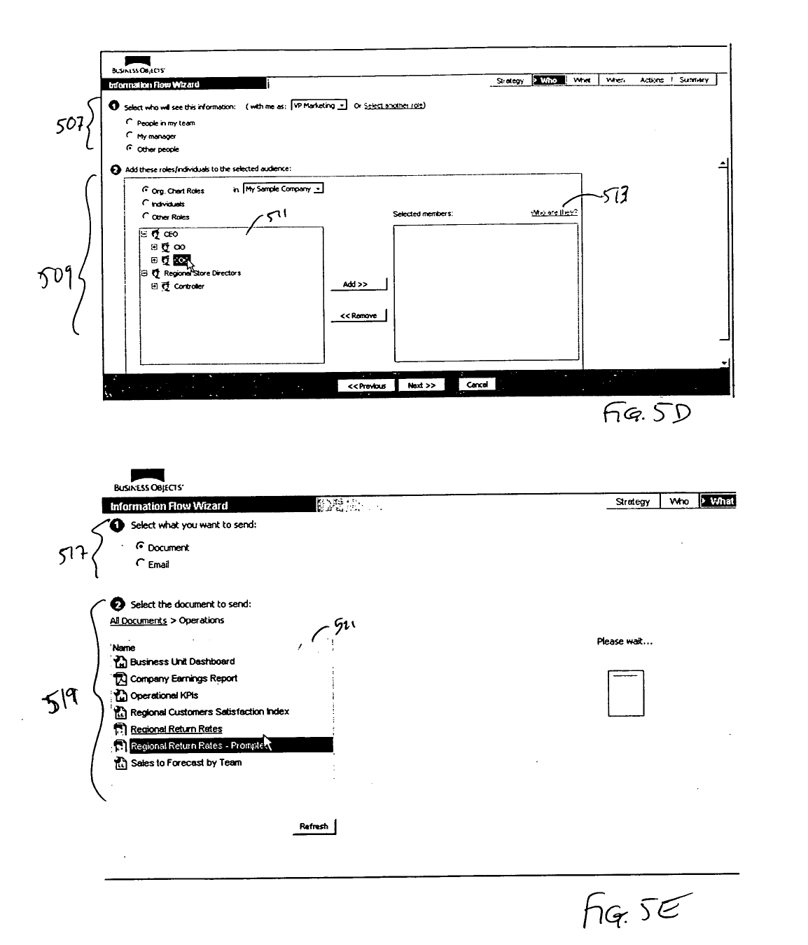

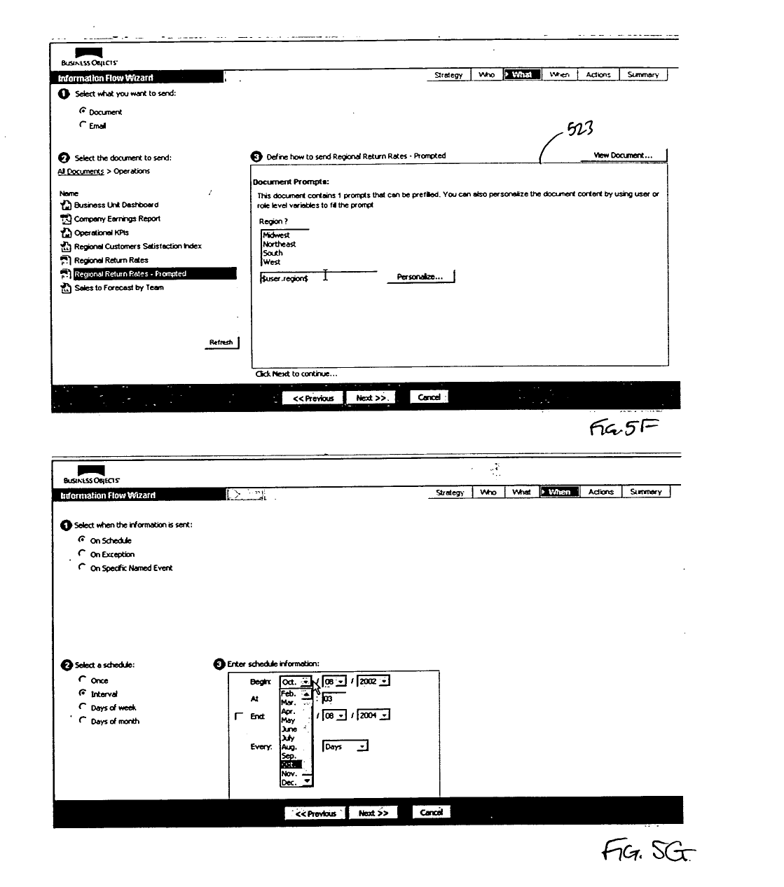

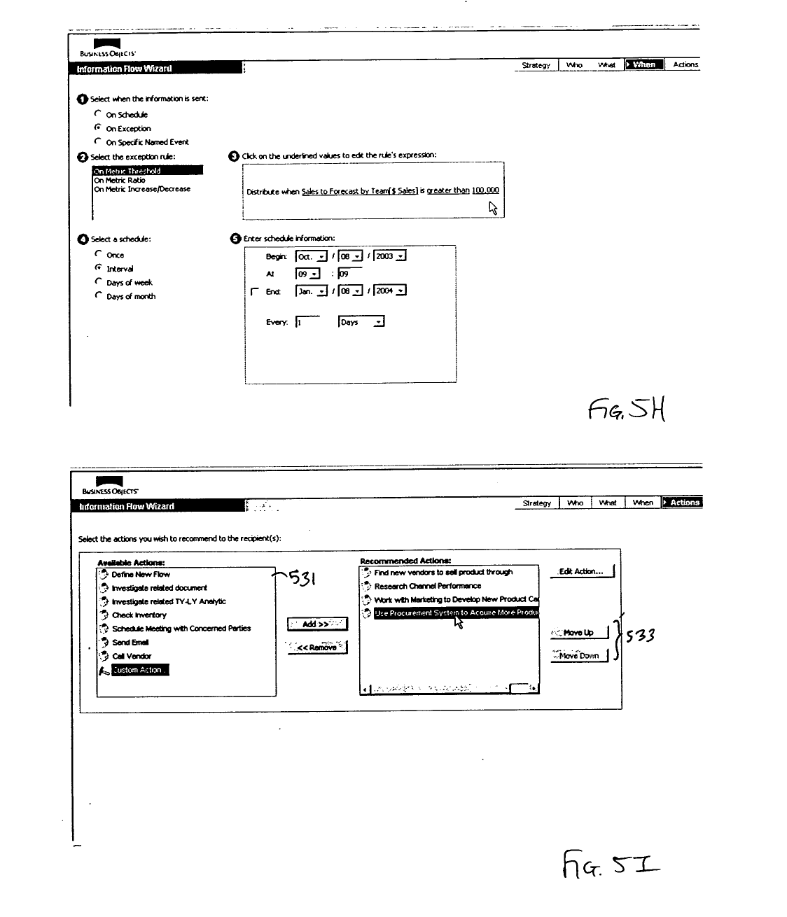

FIG. 5A is a flow diagram of a process 500 for defining an information flow object 306 according to an embodiment of the present invention, and FIGS. 5B-K are screen shots illustrating a corresponding user interface. Definition of a flow object includes specifying recipients, content to be sent, conditions under which the content should be sent, and any suggested actions (next steps) to be taken by the recipients. Like process 400, process 500 may be implemented using a wizard interface or other type of interface.

At step 502, the strategy builder initiates creation of a flow object, e.g., by selecting a “New Information Flow” command in a graphical user interface of strategy builder client 110 (FIG. 1), as shown in FIG. 5B. At step 504, the strategy builder enters general information about the flow, e.g., a name for the flow, and relationships to other flows. For example, as described above, multiple flows may be grouped into a strategy object, and step 504 may include identifying the strategy to which the new flow object will belong. One user interface for selecting a strategy (e.g., a “Sales Performance” strategy) is shown in FIG. 5C. In some embodiments, the strategy builder may also specify a priority level for the flow, such as “informational,” “warning,” “critical” and the like. During execution of the flow, this priority level may affect how information is transmitted and/or presented to a user, as described below.

At step 506, the strategy builder identifies one or more recipients for the flow; an example of a recipient selection interface is shown in FIG. 5D. In this example, various options are presented. Upper section 507 allows the strategy builder to select his or her own team, manager or “others” via radio buttons. If “Others” is selected, lower section 509 becomes active, allowing the strategy builder to select individuals and/or roles to receive the flow. As shown in the box, the strategy builder is presented with a list of existing roles in box 511 and may choose one or more. The strategy builder may be able to select a role and view its resolution (e.g., via “Who are they?” link 513), in order to determine whether a particular user is associated with that role. Some alternative embodiments allow the strategy builder to create a new role during flow creation; creating a new role may invoke a role creation process as described above. In still other embodiments, the strategy builder may also select individual users to receive a flow (e.g., via “Individuals” radio button in FIG. 5D).

At step 508, the strategy builder identifies BI content to be distributed to the recipients of the flow. An example is shown in FIG. 5E, where upper section 517 allows the strategy builder to select whether to send a document (i.e., a report) or e-mail. If “e-mail” is selected (not shown), the strategy builder specifies the subject and body for the message. If “Document” is selected, lower section 519 becomes active, allowing the strategy builder to select a document. In this example, lower section 519 includes a list 521 of available documents, which may include any report available from BI content server 104.

In some instances, analytic reports provided by BI content server 104 may include “prompts” allowing customization of the report to focus on the most relevant data for a particular user. Prompted reports are known in the art as a feature of BI content delivery. For example, suppose that an organization has four independently operated regional warehouses. Instead of defining four different reports, one for each warehouse, a report can be defined to include a “region” prompt. When the report is actually generated, the prompt is resolved to determine which region(s) should be included in the report.

Information flows in some embodiments of the present invention are able to leverage prompted reports to customize content delivery for different users who share a role. For example, as shown in FIG. 5E, the strategy builder may select a prompted report (e.g., “Regional Return Rates—Prompted”). He or she is then instructed to provide values for each prompt, as shown in FIG. 5F, which displays a form 523 for filling a prompt. In some cases, a fixed value would be entered (such a value would apply to all users who receive the report when the flow is executed), but in other cases the value entered may be a reference to a user variable or role variable (e.g., “$user.region” as shown in FIG. 5F). These variables are resolved when the flow is executed in order to customize the report to each recipient. For example, returning to the regional warehouse example, suppose that each warehouse has a manager who has the role of “ordering products.” If BI content server 104 provides a prompted report for inventory with “location” as a prompt, then a single flow can be created to send reports to each manager about inventory levels at his or her warehouse by specifying that the location prompt is to be resolved by reference to a user variable called “location.” The location variable may be defined, e.g., by reference to a location field in the personnel database.

It is to be understood that any content that can be provided by BI content server 104 may be included in a report. In an illustrative case, the content includes at least one metric that captures some business intelligence quantity (e.g., dollar value of sales) and may be aggregated in various ways (e.g., summing or averaging). Aggregation is generally done over some dimension (e.g., time period, geographic area, by salesperson). In some embodiments, step 508 may also include defining a report, e.g., by selecting the metric, selecting business intelligence dimensions (e.g., geographic area) and optionally restricting values for some of the selected dimensions (e.g., a particular state). Alternatively, any report desired may be defined in advance by interacting with BI content server 104 (e.g., through a conventional interface) and subsequently made available for selection during step 508.

Next, at step 510, the strategy builder defines a rule for determining when the flow is to be sent to the selected recipients. As described above, in one embodiment, rules are defined by leveraging business rules functionality associated with a conventional BI rules engine 106. Such rules typically include a triggering event that determines when the rule should be tested and an exception that determines when the flow should be sent to the role(s) identified in step 506. FIG. 5G illustrates defining a rule based on a regular schedule, and FIG. 5H illustrates defining a rule based on an exception.

Like content, rules may be defined parametrically with the parameters being resolved by reference to user variables or role variables. For example, referring again to the warehouse example above, it would be desirable to notify a particular warehouse manager about low inventory levels in his warehouse but not in one of the other warehouses. A rule might be defined with a triggering event of “nightly” and an exception of “inventory in <user:location> warehouse is below X.” As described below, this rule would be processed separately for each user who has the targeted role, with the parameter <user:location> being a user variable that is resolved independently for each user. User variables may include any user information that can be obtained at flow execution time, including potentially any information accessible via user management system 108.

At step 512, the strategy builder defines any next steps (suggested actions) that should be sent to the recipient(s) of the flow. An example of an interface for defining next steps is shown in FIG. 5I. Box 531 allows the strategy builder to select from a list of predefined next step templates. The interface can also provide controls 533 for placing the selected next steps in a desired order, e.g., by putting the most critical action first. Next steps may be defined parametrically, and the strategy builder may specify fixed values, user variables, or role variables for resolving the parameters. Whether to send a particular next step can also be parameterized using role variables or user variables so that different users receive next steps reflecting their specific responsibilities. In some embodiments, one option is not to send any next steps; this may be desirable, e.g., where a flow is intended as informational. Next step templates and functionality are described further below.

In FIG. 5I, box 531 also allows the strategy builder to add one or more “Custom Action” items. This may invoke a next step creation wizard as described below.

At step 514, the strategy builder is presented with a summary of the new flow object and prompted to confirm the information entered, as illustrated in FIG. 5J.

At step 516, the strategy builder exits the flow definition process, and the new flow object is stored in ISM repository 208. (In some embodiments, the strategy builder may also elect to quit without saving the new flow object.) Interpretation engine 206 is then able to retrieve and execute the flow as described below. In some embodiments, strategy builder client 110 enables a user to view existing flows grouped by strategy, as shown in FIG. 5K.

In some embodiments, flow objects also have active or inactive states, and the strategy builder may be prompted at step 516 to initialize the new flow object to one of these states. In the active state, the flow is executed by ISM server 102 to deliver the specified content to the recipients in accordance with the rule. In the inactive state, the flow object is stored in ISM repository 208 but not executed until its state is changed to active. A strategy builder may manually change the state of an existing flow object to active or inactive, and flow states may also be updated through operations of ISM server 102 and/or information consumers using portal 118 as described below. In some embodiments, the strategy builder may also specify an “expiration” condition under which the flow should be automatically inactivated. For instance, the flow may be automatically inactivated after a manger-specified number of executions, after a manager-specified expiration date, or never.

Another view of flow creation is shown in FIG. 5L, which is a control flow diagram for a flow creation process (e.g., process 500 of FIG. 5A) according to an embodiment of the present invention. This diagram illustrates how various components of the system depicted in FIGS. 1 and 2 may interact to support flow creation. In this diagram, user 552 is a strategy builder. ISM components 554 include ISM server 102 and ISM repository 208. BI components 556 include rules engine 106, an action engine 558, and a foundation engine (“App Foundation/WebI”) 560. It is to be understood that action engine 558 and foundation engine 560 may be elements of an embodiment of BI content server 104.

The labeled arrows between various components illustrate control flow during flow execution in a manner generally understood in the art. As indicated, user 552 initiates flow creation via instructions to ISM server 102. ISM server 102 creates the flow in ISM repository 208 and instructs rules engine 106 to create an appropriate rule, which may be stored in a rules store 114 (FIG. 1) for subsequent execution as described below.

D. Next Step Object

As mentioned above, next steps generally reflect suggested actions for a user to take upon receiving a flow, and a flow object 306 may include references to zero or more next step objects 312. In one embodiment, a next step object 312 includes a name field that describes the task to be done (e.g., “order more product”, schedule a meeting”, “investigate anomaly”). The next step object also advantageously includes an activity field that the recipient can update to indicate, e.g., that the task has been started, completed, delegated, or deferred. Additional fields may also be provided for storing other information, such as date of completion, identifier of user to whom the task was delegated, notes, etc.

In some embodiments, next steps may be “interactive” in the sense that they provide links or other functionality (not shown in FIG. 3) to help the recipient complete the task. As an example, an interactive next step of “order product” may provide a link to an order form to be filled out in completing the task; some or all fields in the form may be pre-completed. As another example, a next step of “review detailed report for region” may provide a link to the appropriate report.

Next steps instances associated with a flow instance that has been delivered are advantageously viewable by recipients of the flow and by other users who need to make sure that the recipients are following up on the information they received. Accordingly, in some embodiments, an activity log is maintained for each next step in a flow instance. Users, e.g., a recipient's supervisor, can access the log to view next steps, including information and updates entered by the recipient. This enables the organization to monitor activity and determine whether appropriate actions are being taken. The organization may also learn from the activity log which next steps are most useful in a given situation.

In some embodiments, next steps may also be shared. Shared next steps can reduce the likelihood of duplicative efforts. For example, several users may receive next steps with a particular flow instructing them to order the same product, schedule the same meeting, or the like. Rather than sending each recipient a separate instance of the next step, the recipients may access the same shared instance. If one recipient orders the product and updates the shared instance, the others will see this information when they review the next step. Each recipient can also view any notes left by others to determine more specifically what has been done and whether anything else needs attention. (E.g., one recipient might have ordered more of one product, but other products still need to be ordered.)

In some embodiments, strategy builder engine 202 supports a wizard (or other interface) for defining next step objects. This interface, which can be invoked from within the flow creation interface, allows the strategy builder to define the name. The name may be defined in a parameterized form in which the strategy builder supplies user variables or role variables as the parameters to be resolved during flow execution when the next step is instantiated. The next step definition interface may also provide access to a template file (e.g., an XML file) with previously defined name templates that the strategy builder can select from.

In some embodiments, the next steps wizard also allows the strategy builder to indicate whether the next step is to be shared or not.

E. Goal Object

Some embodiments of the present invention also enable users to define goals for themselves and/or other users (e.g., their subordinates). Goal objects 308 are somewhat similar to the flow objects 306 described above but include additional scheduling and monitoring features. In general, defining a goal includes identifying users (e.g., users in a certain role) who are responsible for accomplishing the goal, defining a target state of affairs (e.g., “increase sales by 50%” or “complete performance reviews”), and setting a deadline for reaching the target. Checkpoints (intermediate milestones) can also be established. For example, if the goal is to increase sales by 50% over the next six months, monthly checkpoints could be established.

Once defined, an instance of the goal object can be sent to those responsible for achieving it, and an interface is provided for the responsible persons (and their supervisors) to monitor their progress toward the goal. Such an interface is described below. In some embodiments, activation of a goal may also trigger the delivery of flows to a user. For example, if a production manager has a goal of reducing the number of defective units produced, an associated flow can be provided to periodically send reports related to defective products (e.g., number of defective units, type of defect, etc.) to the production manager.

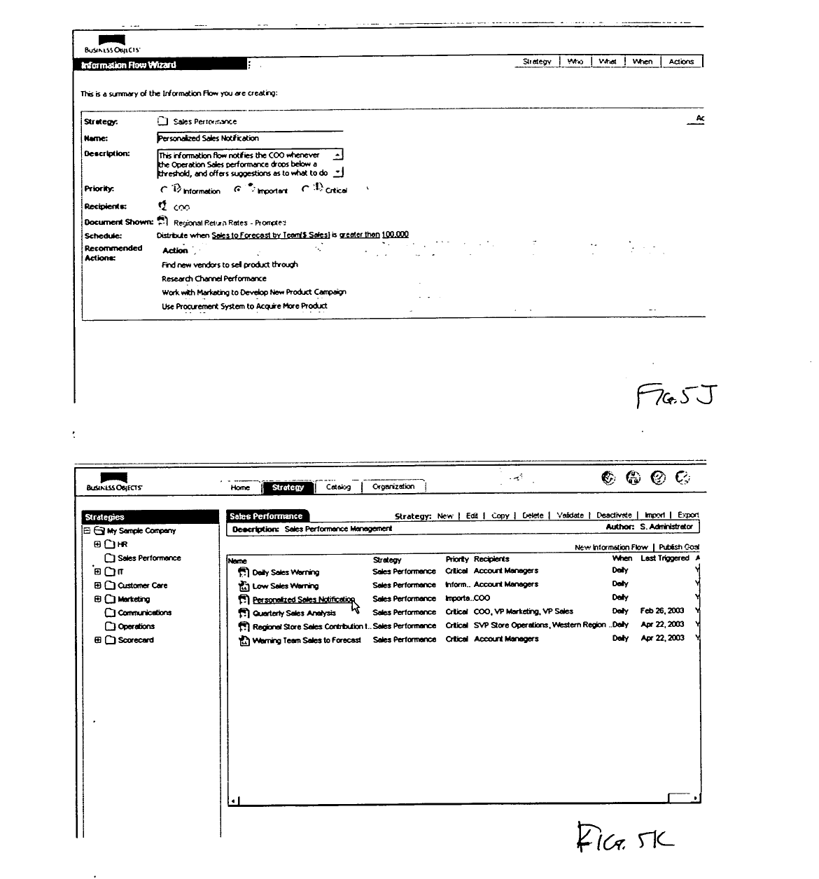

FIG. 6 is a flow diagram of a process 600 for creating a goal object according to an embodiment of the invention. This process is somewhat similar to flow creation process 500 and may also be implemented using a wizard interface or other type of interface.

At step 602, the strategy builder (or another user) initiates creation of a goal object, e.g., by selecting a “create goal” command in a graphical user interface of strategy builder client 110 (FIG. 1). In some embodiments, access to the goal-creation interface may be also provided through information consumer portal 118, thereby enabling users who are not strategy builders to set goals for themselves and possibly for others as well.

At step 604, general information for the new goal object is entered. This information typically includes a name and may also include a priority level (e.g., as described above for flow objects) and the like. The goal may also be associated with an information strategy object during this step.

At step 606, the strategy builder selects recipients for the goal, by specifying roles and/or individual users to receive the goal. This step may be generally similar to step 506 of process 500 described above. Where multiple recipients are selected, the goal may be shared (similarly to sharing of next steps) so that each user sees what others have done. In some embodiments, the strategy builder selects between shared and unshared goals. One example of an unshared goal that might be sent to multiple users might be “complete performance reviews,” which in some organizations is done independently by each department head. A goal of “reduce defects by 50%” might be shared by an entire production team to facilitate their collaboration in reaching it.

At step 608, the strategy builder defines the target and deadline. A target may be defined quantitatively, e.g., in the general form of <metric><relation><value>, where the metric may be any metric available via BI content server 104 (e.g., sales revenue, number of products sold), and the relation may be, e.g., “at least”, “not more than”, “increase by”, “decrease by”, etc. The value may be defined in absolute terms (e.g., number of dollars or number of units) or relative terms (e.g., a percentage of current value). A target may also be defined qualitatively, e.g., as a task to be done. The deadline may be specified as a calendar date or relative to the date of creation of the goal. In some embodiments, a deadline specified during goal object creation may be modified if the goal is instantiated at a different time.

At step 610, the strategy builder defines zero or more milestones to measure progress toward the goal. Like the goal itself, milestones can be implemented by defining targets and deadlines that are intermediate between the current state and the goal. Non-quantitative goals may also have milestones; for example, the goal of “complete performance reviews” might include milestones of “collect evaluation forms,” “review forms,” “allocate bonuses,” and “schedule review meeting with each employee”

At step 612, the strategy builder may select zero or more next steps and/or flow objects to be associated with the goal. For example, if a production team has a goal of reducing defects, a flow may be triggered to start sending regular reports on defects to some or all of the team members. The goal of reducing defects might be also be accompanied by specific next steps to be taken toward that goal, such as “review logs to identify most frequent defects.” Where flows are triggered by goals, the goal may provide the values for parameters used to resolve prompts associated with the flow, and step 612 allows the strategy builder to set such values.

At step 614, a summary of the new goal object is presented, and the strategy builder may choose to activate (or instantiate) the goal, store the goal for later activation, or quit without saving the goal. At step 616, the process exits, disposing of the goal according to the strategy builder's selection.

It should be noted that storing goals for later activation enables an organization to track and reuse best practices for achieving a particular goal. For example, suppose that several sales divisions each want to increase their sales. An “increase sales” goal defined by the organization can be re-used by different sales divisions and updated (e.g., by revising the associated flows and/or next steps) to reflect actions that experience shows to be helpful.

It will be appreciated that the above-described definition processes for the various objects of FIG. 3 are illustrative and that variations and modifications are possible. Steps described as sequential may be executed in parallel, order of steps may be varied, and steps may be modified or combined.

After a role, flow, goal, or next step has been created, it can be modified. In one embodiment, the modification processes are generally similar to the respective definition processes described above, except that the strategy builder begins by selecting an existing object to edit. The strategy builder can then modify any feature of the object.

III. Content Delivery

In an embodiment of the invention, ISM server 102 of FIG. 1 processes objects of the data model of FIG. 3, thereby causing information to be delivered to users. The delivered information is referred to herein as “instances” of various objects. The recipients access the information, e.g., through portal 118 of FIG. 1, and can update instance activity fields to reflect their responses to the information. Instance activity data may be reviewable by others in the organization, to help them verify that users are responding appropriately to the information. Examples of processing methods and recipient access to content will now be described.

A. Flow Execution

Once a flow object has been defined, it is stored in ISM repository 208 and processed (executed) in due course. In one embodiment, after a flow object is created (or activated, as described above), interpretation engine 206 provides the rule to rules engine 106. Rules engine 106 detects the triggering event and interacts with interpretation engine 206 and BI content server 104 to process the flow and distribute instances of the flow to the users associated with the recipient roles.

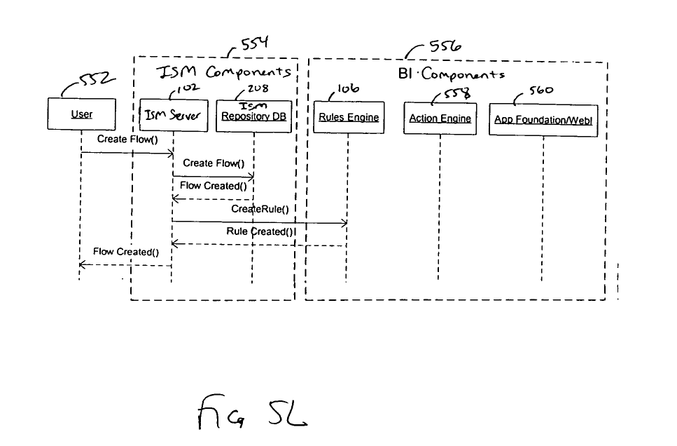

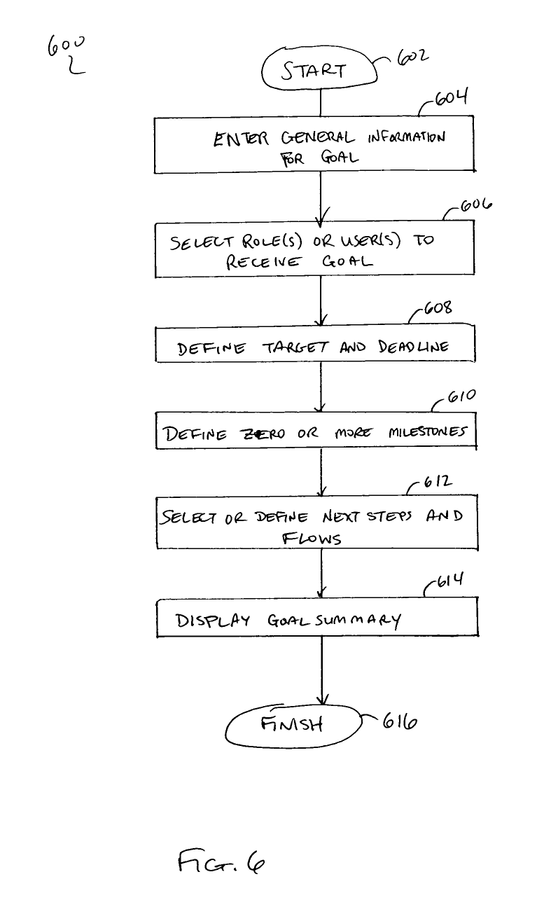

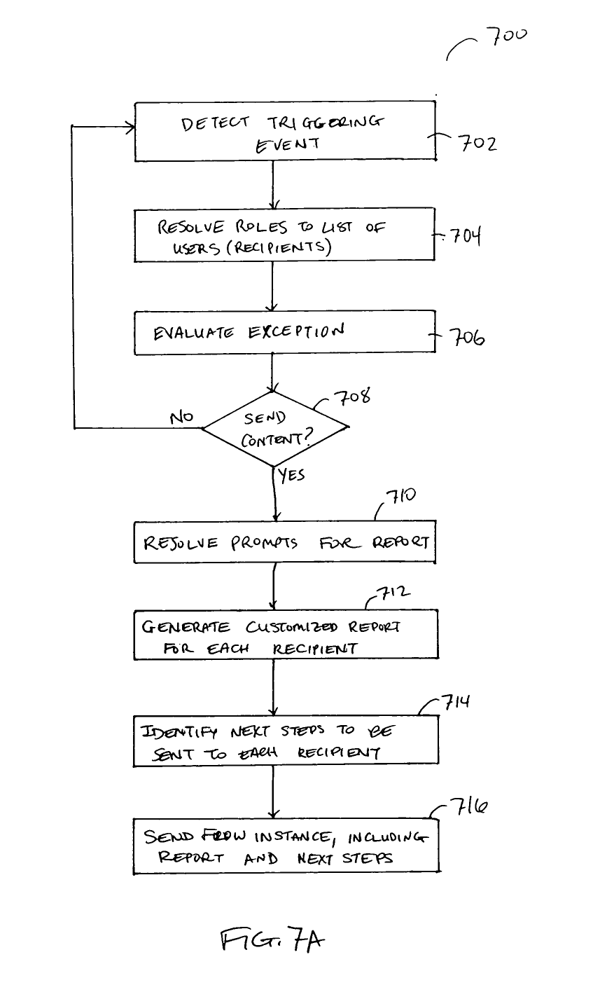

More specifically, FIG. 7A is a flow diagram of a process 700 for executing an information flow according to an embodiment of the present invention. At step 702, a triggering event (defined in the rule, as discussed above) is detected by rules engine 126. As described above, the triggering event is an event that causes the rules engine to determine whether any flows should be executed, e.g., a time of day, a metric refresh (update of BI content), a predefined polling interval, or the like. At step 704, the roles associated with the flow object are resolved by interpretation engine 206 interacting with role resolution interface 204. During this step, role resolution interface 204 provides the current list of users associated with the flow object (who would be recipients of the flow).

At step 706, rules engine 106 evaluates the exception portion of the rule to determine whether action is necessary. As discussed above, the exception may be defined parametrically, and step 706 may include resolving any user variables or role variables as necessary to evaluate the exception. If, at step 708, no action is necessary, the process returns to step 702 to wait for the next triggering event.

If action is necessary, then at step 710, any prompts associated with the report are resolved. As discussed above, prompts are generally used to customize the content that is sent out and may be resolved by reference to role variables and/or user variables. Interpretation engine 206 resolves the variables, obtaining information from ISM repository 208 and/or role resolution engine 204 as needed, and supplies resolved prompts to BI content server 104 for use in generating the report.

In some instances a user may be a designated recipient of the same flow via two different roles. As an example, suppose that there is a flow that is being sent to DList (a distribution list) and to users with the job title “Developer,” and that a user who is a developer is also placed on DList. In some embodiments, this user will receive the report once, and any role variables will be resolved based on the first role in which the user appeared. That is, the order in which roles are associated with a flow may affect resolution of role variables. To minimize the risk of adverse effects, the strategy builder who defines flow objects is advantageously advised of this feature and allowed to select the desired order for the recipient roles during flow creation and editing. Alternatively, users may receive a separate flow for each role, although this may result in some users receiving duplicative information.

At step 712, BI content server 104 generates a customized report for each recipient, using the resolved prompts provided by interpretation engine 206. At step 714, next steps to be sent to each recipient in association with the report are identified. As mentioned above, the decision to send next steps to particular recipients may be parameterized based on user variables or role variables, and step 714 includes resolving such variables to determine which next steps to send.

At step 716, an instance of the flow, including the report and instances any next steps identified at step 714, is sent to the intended recipient by one or more of the available delivery methods, such as e-mail or portal-based notification. The flow instance may be sent by storing the instance data in ISM repository 208 and providing a link for accessing that data via the appropriate delivery method. In some embodiments, the delivery method is specified by the strategy builder during creation of the flow (as described above). In other embodiments, step 716 may include consulting user account settings or other user data to select an appropriate delivery method.

Depending on the implementation, processing steps may be repeated sequentially for each recipient, or multiple recipients may be processed in parallel.

It will be appreciated that process 700 is illustrative and that variations and modifications are possible. Steps described as sequential may be executed in parallel, order of steps may be varied, and steps may be modified or combined.

Another view of flow execution is shown in FIG. 7B, which is a control flow diagram for a flow execution process (e.g., process 700 of FIG. 7A) according to an embodiment of the present invention. This diagram illustrates how various components of the system depicted in FIGS. 1 and 2 may interact to support flow execution. In this diagram, user 752 is an intended recipient of a report that is generated during flow execution. ISM components 754 include ISM server 102 and ISM repository 208. BI components 756 include rules engine 106, an action engine 758, and a foundation engine (“App Foundation/WebI”) 760. It is to be understood that action engine 758 and foundation engine 760 may be elements of an embodiment of BI content server 104. Distribution server 758 may include e-mail client 116 and/or information consumer portal 118 of FIG. 1.

The labeled arrows between various components illustrate control flow during flow execution in a manner generally understood in the art. As indicated, rules engine 106 (which created the rule as described above with reference to FIG. 5L) handles detection of the triggering event and, upon detecting the triggering event, resolves variables and roles (“V&Rs”) by appropriate request(s) to ISM repository 208. Rules engine 106 then evaluates the exception by a request to foundation component 760 to access the appropriate BI content. Assuming the exception has occurred, rules engine 106 instructs action engine 758 to generate the report (arrow labeled “Execute Action( )”). Action engine 754 instructs BI foundation component 760 to populate any prompts for the report and receives populated prompts. Action engine 754 also instructs foundation component 760 to refresh the BI content so that the report will include current data.

Once the report is generated, action engine 754 instructs distribution server 758 to perform the appropriate distribution; distribution server 758 then distributes the report to one or more users 752. In addition, action engine 754 notifies ISM server 102 that the flow has been executed, and ISM server 102 updates the flow data in ISM repository 208 accordingly.

Processing of goal objects is generally similar to processing of flows. In one embodiment, goals are not necessarily triggered by rules; when such a goal is activated, any role or user variables associated with the goal are resolved, and an instance of the goal (including associated content such as reports or next steps) is sent to each user responsible for achieving it. It is also possible to create a goal object that includes a rule for automatically activating the goal. Processing of an active goal also causes any flows associated with the goal to be activated. If goal-specific values for any parameters of the flow were provided during the goal creation process 600, these values are provided during flow processing and used to customize content.

B. Information Consumer Portal

In the embodiment depicted in FIG. 1, information consumers (e.g., recipients of flows and/or goals) may access BI content via a portal 118. Portal 118 communicates with ISM server 102 via content connector 212 as shown in FIG. 2. Portal 118 advantageously provides a graphical user interface that can be implemented using conventional techniques (e.g., browser-style products using various communication protocols such as HTTP and languages such as HTML, Java, XML, etc.) for enabling communication between BI content server 104 and a user accessing portal 118. Portal 118 generally includes a user identification mechanism so that the information displayed can be customized to the needs of a particular user and may also provide security features (e.g., password protection) in order to limit access to portal 118 to authorized users.

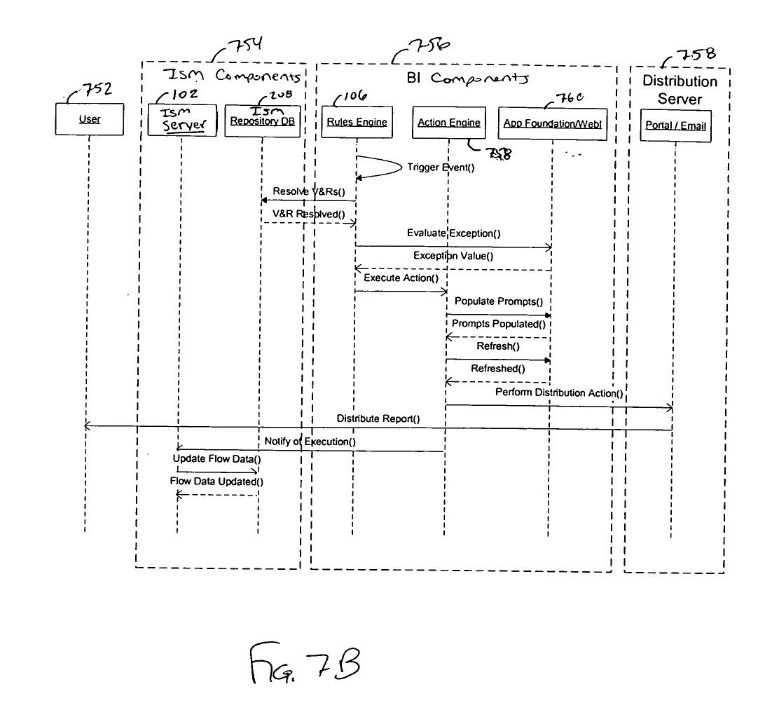

In one embodiment, portal 118 provides a live content display of information targeted to the particular user who is logged in. FIG. 8 illustrates an example of a live content display 800 according to an embodiment of the present invention. Display 800 includes a summary pane 802, a browser pane 804, and a details pane 806.

Summary pane 802 indicates the quantity and status of the flow or goal instances the user has received. In this embodiment, the number of “critical” items, “unviewed” items, and “outstanding” items are listed. “Critical” items are flow and goal instances that were assigned critical priority (as described above). “Unviewed” items are instances that have been received but not yet opened by the user. “Outstanding” items have been opened but have not been resolved. For example, if a flow directed to a user contains next steps, the flow may be considered outstanding until the user checks off the next steps. In other cases, a flow instance may include a “resolution” field that the recipient completes by indicating what action was taken in response to the information presented, and a flow instance is considered “outstanding” until the recipient supplies this information. It will be appreciated that some items may be counted more than once in this summary, e.g., an item may be both “critical” and “outstanding” or “unviewed.” In some embodiments, summary pane 802 may include links that cause a listing of the counted items to appear, e.g., by clicking on “critical”, the user may view a list of critical flows she has received.

Browser pane 804 displays a list of the outstanding flow and goal instances the user has received. The list may show, e.g., the name of the flow or practice that generated the item and/or the name of the report that was generated. The display may also include icons indicating, e.g., type of item, whether a report (or link to a report) is included, priority, etc. Browser pane 804 advantageously provides a number of options for organizing the list of items with a user control for selecting an option. In one embodiment, the user can select to display the list chronologically in order received, by role (i.e., according to which of the user's roles resulted in receiving each item), by priority, or by recent activity (e.g., most recently viewed or updated items first). Other options may also be provided, and ordering may be based on multiple criteria, e.g., sorting by role first and then by priority. Unviewed items can be listed in bold or have other distinctive indicia to let the user know that she has not already seen this item.

Browser pane 804 also advantageously displays a list of goal instances the user has received. This listing may be integrated with or separate from the list of flows. In one embodiment, each goal item is displayed with a status indicator that is green if the target has been met, yellow if the target has not been met and the deadline is in the future, and red if the target has not been met and the deadline has been reached. Like flow instances, goal instances may be marked as “unviewed,” “outstanding,” “critical,” etc.

For each listed item (flow or goal), browser pane 804 advantageously provides a control (e.g., button or icon) that can be activated by the user to preview the item in details pane 806. Details pane 806 may display, e.g., a report associated with a flow instance, a list of next steps, or the like. In embodiments where viewed and unviewed items are distinguished, an unviewed item may become “viewed” when the user opens it in details pane 806.

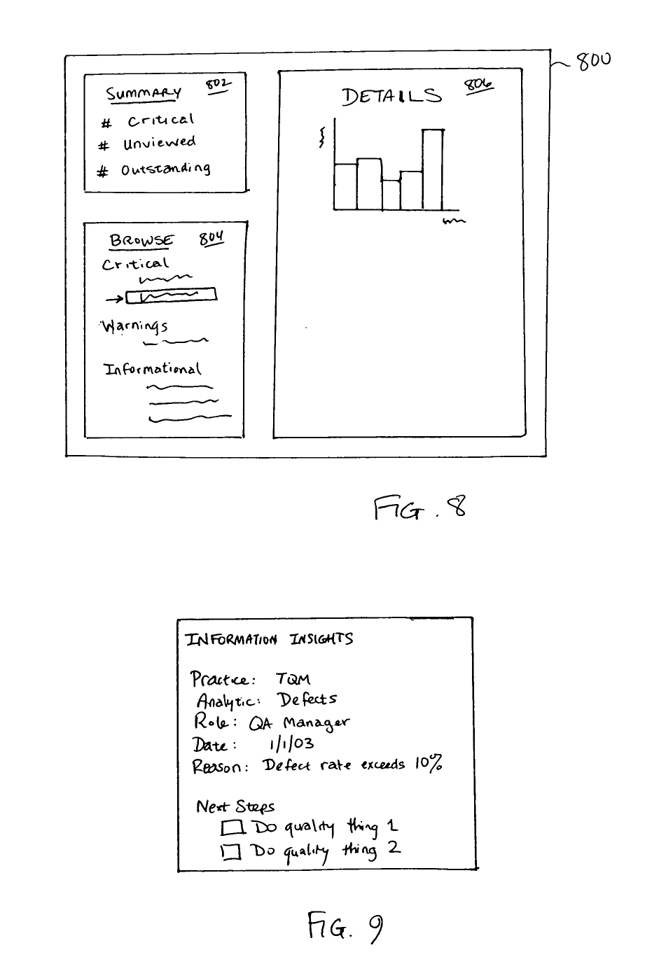

In some embodiments, further interaction with a received instance of a flow or goal (e.g., updating the goal) is accomplished by opening a separate “insights” window for the item. The insights window may appear, e.g., as an overlay over the live content display. FIG. 9 illustrates an example of an insights window 900 for a flow instance. In this example, the information provided includes the practice from which the flow instance was generated, the report that was sent (or a link to the report), the date of creation, the user's role, an explanation of why the flow was sent, and any next steps. The reason may show the exception that triggered sending of the flow (e.g., “Defect rate exceeded 0.5%”). It will be appreciated that the information shown may be varied from this example.

The insights window may also provide controls enabling the user to interact with and update the instance. For example, a user may be able to select a next step and enter information indicating that the step was taken as well as any notes related to the action performed. If a next step is shared (as described above), the user may also view information entered by other users who share the next step. The user may also enter resolution information as mentioned above, thereby removing the instance from the list of outstanding items.

In some embodiments, users may be able to subscribe and unsubscribe from various instances of flows or goals. For example, users may be able to subscribe to instances of flows they are interested in but do not receive through any assigned role and unsubscribe when they are no longer interested. While some embodiments may allow users to unsubscribe from any instance, users are advantageously prevented from unsubscribing from flows or goals associated with their roles. (If a flow or goal has become irrelevant due to a change in user responsibilities, it is preferable to update the user information repository and/or role cache rather than having the user manually unsubscribe.)

A similar insights window may also be provided for goal instances, with the user able to enter and/or view information about actions taken toward the goal, status of intermediate milestones, etc.

Portal 118 may also support other functionality such as creation of new instances of goals and/or flows. Various limits may be placed on the ability to instantiate new flows and goals via portal 118. For example, selection of recipients may be limited, e.g., so that the creating user can select only herself, her own roles, or subordinate users or roles. In some embodiments, users are also able to create new goal objects with themselves as recipient.

The portal described herein is illustrative, and variations or modifications are possible. In some embodiments, portal 118 is integrated with a portal for accessing BI content server 104 directly. As mentioned above, delivery of content via a portal such as that described herein is not required. Alternative content delivery formats include e-mail (which may also provide a link or other reference enabling the recipient to connect to the portal and/or a detailed report), voice or text messaging, or the like. Multiple delivery formats may be supported in parallel, and the same content may be delivered in multiple formats. For example, a critical flow instance might be delivered via the portal at the same time that a text message alert is sent to the user's mobile phone or PDA.

IV. Portability

In some embodiments of the invention, information strategies are made portable to facilitate reuse in different parts of an organization or in different organizations. Portability features may also be used to facilitate backup and recovery of information strategy data in the event of system breakdowns.

In one embodiment, one or more practice objects can be exported by creating an export file, which contains the role definitions, flow objects, and so on associated with the practice object. The export file may be in a platform-independent format (e.g., XML) and created using various known techniques for converting the implementation language of the ISM server (e.g., J2EE) to the platform-independent language. Once created, the export file can be stored on various computer media (magnetic or optical disk, flash memory, tape, etc.), and/or transmitted via carrier signals propagating on a network (e.g., the Internet).

An export file can be imported to a target system, typically by a system administrator. The target system may be the source system from which the file was exported (e.g., to recover data from a backup), a different system operated by the same organization, or a different system operated by a different organization. In any case, importing may be supported by a software utility that reads an export file and creates appropriate practices, flows, roles, and other objects in the implementation language of the target system (which may be the same as or different from the language used in the source system). Again, known conversion techniques may be used. Import procedures advantageously include automatic system tests that notify the importing administrator of any undefined roles, user variables or role variables that cannot be resolved, analytics that are not supported by the BI content server of the target system, etc. Dialog boxes, wizards, or other interface elements may be included to assist the administrator in correcting such errors, e.g., by modifying role definitions, variables, and/or analytics.

V. Additional Embodiments

While the invention has been described with respect to specific embodiments, one skilled in the art will recognize that numerous modifications are possible. In one embodiment, the business intelligence content and the rules engine are provided using conventional products such as the Business Objects BI software suite; the user management system is implemented in a conventional LDAP database; and the various components of ISM server 102 are implemented as one or more separate software programs that interact with the conventional products. In other embodiments, BI content, rules and/or management programs may be integrated with ISM server program(s) as components of a single product. The various components may be implemented on the same computer or on different computers with appropriate communication networks provided. The functionality described herein can be implemented using software to be executed on one or more computer systems, dedicated special-purpose hardware devices, or any combination thereof.

Computer program products incorporating various features of the present invention may be encoded on various computer-readable media for storage and/or transmission, such as magnetic disk or tape, optical storage media (compact disk, DVD), and the like. Such program products may also be encoded in a carrier signal for transmission via wired, optical, and/or wireless networks conforming to a variety of protocols, including the Internet.

It is to be understood that the use of “object” and “instance” herein is not intended to limit the invention to any particular programming language or paradigm (such as object-oriented languages). Those of ordinary skill in the art with access to the present disclosure will recognize that the data structures and associated functionality described herein may be implemented using a wide variety of programming languages and/or scripting languages based on various paradigms operating on a range of platform configurations comprising various hardware, operating system and/or middleware components; all such variations and combinations are within the scope of the invention. Similarly, the term “link” is intended to include any functionality that advises a user of where to find the “linked-to” content and is not limited to HTTP, click-through linking, or any other specific implementation of directing users to the location of content.

Thus, it will be appreciated that the invention is intended to cover all modifications and equivalents within the scope of the following claims.

What is claimed is:

1. A method for managing business intelligence, comprising the acts of:
identifying business intelligence content to be sent;
identifying a target role to which the business intelligence content should be sent, the target role having a role definition;
applying the role definition to a user data store, thereby identifying a recipient user; and
sending the business intelligence content to the recipient user.

2. The method of claim 1, further comprising the act of detecting an occurrence of a condition,
wherein the act of sending the business intelligence content is performed in response to detecting the occurrence of the condition.

3. The method of claim 2, wherein the act of detecting the occurrence of the condition includes the act of resolving a parameter of the condition by reference to the role definition of the target role.

4. The method of claim 2, wherein the act of detecting the occurrence of the condition includes the act of resolving a parameter of the condition by reference to a user variable of the recipient user.

5. The method of claim 1, wherein the act of sending the business intelligence content to the recipient user further includes the act of customizing the business intelligence content for the recipient user according to a content parameter, and wherein the business intelligence content parameter is resolved by reference to a characteristic of the recipient user.

6. The method of claim 1, wherein the act of sending the business intelligence content to the recipient user further includes the act of customizing the business intelligence content for the recipient user according to a content parameter, and wherein the content parameter is resolved by reference to the role definition of the target role.

7. The method of claim 1, wherein the act of identifying the business intelligence content includes the acts of:
receiving a business intelligence dimension; and
selecting the business intelligence content based at least in part on the business intelligence dimension.

8. The method of claim 1, wherein the act of identifying the business intelligence content includes the acts of:
receiving a business intelligence dimension;
receiving a value associated with the business intelligence dimension; and
selecting the business intelligence content based at least in part on the business intelligence dimension and the associated value.

9. The method of claim 1, wherein the act of sending the business intelligence content further includes the acts of:
identifying a next step associated with the business intelligence content, wherein the next step indicates a task to be performed by the recipient user in response to the business intelligence content; and
sending the next step to the recipient user in association with the business intelligence content.

10. The method of claim 9, further comprising the act of receiving response data from the recipient user indicating that the recipient user has performed the indicated task.

11. The method of claim 10, wherein the next step is sent to a plurality of users, including the recipient user, in a shared form such that the response data received from the recipient user is visible to at least one other of the plurality of users.

12. The method of claim 9, wherein the act of identifying the next step includes the act of resolving a next step parameter by reference to the role definition of the target role.

13. The method of claim 9, wherein the act of identifying the next step includes the act of resolving a next step parameter by reference to the business intelligence content.

14. The method of claim 1, further comprising receiving response data from the recipient user, the response data indicating an action taken by the recipient user in response to the business intelligence content.

15. The method of claim 14, further comprising making the business intelligence content and the response data visible to another user.

16. The method of claim 1, further comprising the acts of:
identifying a target state of the business intelligence content;
identifying a deadline for reaching the target state; and
sending the target state and the deadline to the recipient user in association with the business intelligence content.

17. The method of claim 16, further comprising the act of displaying a goal status indicator to the recipient user, the goal status indicator reflecting whether the target state of the business intelligence content has been achieved.

18. A method for managing business intelligence, comprising the acts of:
identifying business intelligence content to be sent;
identifying a recipient user for the business intelligence content;
identifying a next step associated with the business intelligence content, wherein the next step indicates a task to be performed by the recipient user in response to the business intelligence content; and
sending the business intelligence content in association with the next step to the recipient user.

19. The method of claim 18, further comprising the act of receiving response data from the recipient user indicating that the recipient user has performed the indicated task.

20. The method of claim 19, wherein the next step is sent to a plurality of users, including the recipient user, in a shared form such that the response data received from the recipient user is visible to at least one other of the plurality of users.

21. The method of claim 18, wherein the act of identifying the next step includes the act of resolving a next step parameter by reference to a user variable of the recipient user.

22. The method of claim 18, wherein the act of identifying the next step includes the act of resolving a next step parameter by reference to a role association of the recipient user.

23. The method of claim 22, wherein the act of identifying the recipient user includes the act of identifying the recipient user by reference to the role association.

24. The method of claim 18, wherein the act of identifying the next step includes the act of resolving a next step parameter by reference to the business intelligence content.

25. The method of claim 18, further comprising the act of detecting an occurrence of a condition,
wherein the act of sending the business intelligence content in association with the next step is performed in response to detecting the occurrence of the condition.

26. The method of claim 25, wherein the act of detecting the occurrence of the condition includes the act of resolving a parameter of the condition by reference to a role association of the recipient user.

27. The method of claim 26, wherein the act of identifying the recipient user includes identifying the recipient user by reference to the role association.

28. The method of claim 25, wherein the act of detecting the occurrence of the condition includes the act of resolving a parameter of the condition by reference to a user variable of the recipient user.

29. The method of claim 18, further comprising the acts of:
identifying a target state of the business intelligence content;
identifying a deadline for reaching the target state; and
sending the target state and the deadline to the recipient user in association with the business intelligence content and the next step.

30. The method of claim 29, further comprising the act of displaying a goal status indicator to the recipient user, the goal status indicator reflecting whether the target state of the business intelligence content has been achieved.

31. A system for managing business intelligence, the system comprising:
an information strategy repository configured to store a role definition and a flow object, wherein the flow object references the role definition, the flow object further including a definition of business intelligence content to be sent and a condition under which the business intelligence content is to be sent;
a role resolution engine configured to dynamically resolve the role definition, thereby identifying a recipient user who has a target role defined by the role definition; and
an interpretation engine configured to execute the flow object, thereby sending the business intelligence content to the recipient user in the event that the condition is satisfied,
wherein the interpretation engine is further configured to identify the recipient user by providing the role definition to the role resolution engine.

32. The system of claim 31, further comprising an information consumer portal configured to present a flow instance to the recipient user, the flow instance including the business intelligence content.

33. The system of claim 32, wherein the information consumer portal is further configured to receive response data from the recipient user, the response data indicating an action taken by the recipient user in response to the flow instance, and to store the response data in association with the flow instance in the information strategy repository.

34. The system of claim 33, wherein the information strategy repository is further configured to make the stored response data available to a user other than the recipient user.

35. The system of claim 31, wherein the role resolution engine is further configured to dynamically resolve the role definition by querying a user management system.

36. The system of claim 31, wherein the role resolution engine is further configured to dynamically resolve the role definition by accessing a distribution list for the target role.

37. The system of claim 31, wherein the interpretation engine is further configured to customize the business intelligence content according to a content parameter prior to sending it to the recipient user.

38. The system of claim 37, wherein the interpretation engine is further configured to resolve the content parameter by reference to a user variable of the recipient user.

39. The system of claim 37, wherein the interpretation engine is further configured to resolve the content parameter by reference to a role variable of the target role.

40. The system of claim 31, wherein the interpretation engine is further configured to determine whether the condition is satisfied by providing a corresponding rule to a business intelligence rules engine.

41. The system of claim 31, wherein the interpretation engine is further configured to determine whether the condition is satisfied according to a parameter of the condition.

42. The system of claim 41, wherein the interpretation engine is further configured to resolve the parameter of the condition by reference to a role variable of the target role.

43. The system of claim 42, wherein the interpretation engine is further configured to resolve the parameter of the condition by reference to a user variable of the recipient user.

44. The system of claim 31, wherein the interpretation engine is further configured to obtain the business intelligence content by providing the definition of the business intelligence content to a business intelligence content server.

45. The system of claim 44, wherein the definition of the business intelligence content includes a business intelligence dimension to be used in selecting the business intelligence content.

46. The system of claim 44, wherein the definition of the business intelligence content further includes a value associated with the business intelligence dimension, wherein the value is also used in selecting the business intelligence content.

47. The system of claim 31, wherein the flow object further includes a next step indicating a task to be performed by the recipient user in response to the business intelligence content, and wherein the interpretation engine is further configured to send the next step to the recipient user in association with the business intelligence content.

48. The system of claim 47, further comprising an information consumer portal configured to present a flow instance including the sent content and the next step to the recipient user.

49. The system of claim 48, wherein the information consumer portal is further configured to receive response data from the recipient user, the response data indicating that the recipient user has performed the indicated task.

50. The system of claim 49, wherein the information consumer portal is further configured to store the response data in association with the flow instance in the information strategy repository, thereby making the response data available to a user other than the recipient user.

51. The system of claim 31, further comprising a business intelligence subsystem, the business intelligence subsystem including:
a content server configured to receive and store the business intelligence content and to generate a report from the business intelligence content; and
a rules engine configured to process business rules to determine when the content server should generate the report.

52. The system of claim 51, wherein the definition of the business intelligence content includes a reference to the report.

53. The system of claim 51, wherein the interpretation engine is further configured to determine whether the condition is satisfied by providing a business rule for processing by the rules engine, wherein the business rule corresponds to the condition.

54. The system of claim 31, wherein the information strategy repository is further configured to store a goal, the goal including a target state of the business intelligence content, a deadline for achieving the target state, and a reference to the role definition, and wherein the interpretation engine is further configured to transmit the goal to the recipient user.

55. The system of claim 54, wherein the information consumer portal is further configured to present a goal instance to the recipient user, the goal instance including the business intelligence content, the target state, the deadline, and to present a goal status indicator reflecting whether the target state has been achieved.
